(19) United States
(12) Patent Application Publication
(10) Pub. No.: US 2006/0027184 A1
(43) Pub. Date: Feb. 9, 2006

(54) Method and process for manufacturing a shaped pet chewable product

(76) Inventor: Lisa M. Renzi, Star Junction, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/186,406

(22) Filed: Jul. 21, 2005

Related U.S. Application Data
(60) Provisional application No. 60/590,422, filed on Jul. 21, 2004.

(51) Int. Cl. A01K 29/00

(52) U.S. Cl. 119/710

(57) ABSTRACT

Disclosed is a method of manufacturing a rawhide pet chew including the steps of obtaining rawhide and cleaning it to remove fats, oils, salts, and other contaminants. The rawhide is wrung to remove excess water, and while still wet, formed into a design of an object primarily associated with a geographic area. Finally, the rawhide is dried. The design of the object may be selected from animals, plants, landmarks, famous people, and inanimate objects, primarily associated with any country or territory in the world, in particular the states and territories of the United States. Various techniques may be utilized to form the rawhide, including molding, stamping, and cutting. The rawhide pet chews serve as souvenirs and gifts for pets that are specific to vacation, resort, and other tourist oriented attractions or events.

### CROSS REFERENCE TO RELATED APPLICATIONS

This application claims benefit of U.S. Provisional Patent Application No. 60/590,422, filed Jul. 21, 2004, the disclosure of which is hereby incorporated by reference.

### BACKGROUND OF THE INVENTION

1. Field of the Invention

The present invention relates to, in general, rawhide pet chews and a method of their manufacture. More particularly, the present invention relates to rawhide pet chews that are modeled after objects primarily associated with a geographic area and which are intended for use by dogs.

2. Description of Related Art

Souvenirs and the like serve as mementos and convey information concerning a particular experience and permit an individual to share that experience with their friends and family. Souvenirs which are representative of specific geographical areas, especially vacation, resort, and other tourist oriented attractions, memorialize such visits for those who have visited them and serve as marketing products that promote these areas. Such items are very popular as gifts which are brought back to family and friends. Increasingly, the family pet is included as an important member of the family. However, the number and variety of items suitable as gifts for pets are limited.

Rawhide pet chews are staple products sold in the consumer pet product industry. Rawhide pet chews designed particularly for dogs promote oral hygiene, provide masticating exercise, and reinforce the dog owner's relationship with the dog. The rawhide removes tartar and plaque from the dog's teeth when chewed. Additionally, the rawhide does not cause harm to the dog if ingested.

In order to enhance the attractiveness of pet chews to dogs, sensory attractants have been incorporated into their design. Manufactures have added flavors, olfactory attractants, and auditory stimulants to rawhide pet chews. Pet chews may be characterized by their appearance, visual effect, texture, taste, flavor, color, palatability, chew longevity, and nutritional composition. Pet chews have been constructed of synthetic materials, rawhide, rubber, and starch in order to provide a wide variety of textures. Furthermore, pet chews have been designed to enhance the attractiveness of the pet chew to the pet owner. For example, colors and breath sweeteners may be added to the pet chew.

Rawhide pet chews are usually shaped into bones, rolls, donuts, bagels, pretzels, twists, bows or figure eights, cylinders, knots, and flat sheets. Such shapes, however, fail to provide visual stimulation to the pet. Synthetic and rubber pet chews are available in a variety of shapes and colors, but do not provide the benefits associated with rawhide pet chews.

Accordingly, a need exists for a rawhide pet chew that provides the benefits of rawhide to the pet as well as convey a form that is commemorative of a geographic area to provide a suitable souvenir or gift for the pet.

### SUMMARY OF THE INVENTION

An object of the present invention is to provide rawhide pet chews which overcome the aforementioned limitations of existing pet chews. The present invention is a method of manufacturing a rawhide pet chew including the steps of processing the rawhide, forming the rawhide into a design of an object primarily associated with a geographic area while the rawhide is wet after the processing step, and drying the rawhide. The step of processing may further include obtaining rawhides, cleaning them to remove fats, oils, salts, and other contaminants, and wringing the rawhides to remove excess water.

The design of the object may be selected from the group consisting of animals, plants, landmarks, famous people, and inanimate objects, primarily associated with that geographic area. The geographic area may be any country or territory in the world, in particular the states and territories of the United States. Other geographic areas may include resorts and vacation destinations. Various techniques known in the art may be utilized to form the rawhide, including molding, stamping, and cutting. The rawhide may be dyed a color to portray the design as realistically as possible. Further, the rawhide may be branded to indicate the desired commercial market or engraved to add detail to the design.

The present invention serves the souvenir pet chew industry and provides a unique combination of aesthetic qualities pleasing to both the pet owner and the pet while serving the utilitarian function of enhancing the pet owner's relationship with the pet and providing the benefits of rawhide pet chews. Moreover, the relationship between the pet owner and the pet will be enhanced by manufacturing souvenir pet chews in forms specific to vacation, resort, and other tourist oriented attractions or events. Further, the souvenir and gift industry for pets is growing as the items available specifically for pets include collars, clothing, furniture, bowls, and photograph frames.

These and other features and characteristics of the present invention, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a flow-diagram of a method of manufacturing a rawhide pet chew in accordance with the present invention;

FIG. 2 is a plan view of a first exemplary embodiment of a rawhide pet chew in the shape of a starfish in accordance with the present invention;

FIG. 3 is a plan view of a second exemplary embodiment of a rawhide pet chew in the shape of a dolphin in accordance with the present invention;

FIG. 4 is a plan view of a third exemplary embodiment of a rawhide pet chew in the shape of a shark in accordance with the present invention;

FIG. 5 is a plan view of a fourth exemplary embodiment of a rawhide pet chew in the shape of a cactus in accordance with the present invention;

FIG. 6 is a plan view of a fifth exemplary embodiment of a rawhide pet chew in the shape of a cowboy boot in accordance with the present invention;

FIG. 7 is a plan view of a sixth exemplary embodiment of a rawhide pet chew in the shape of a palm tree in accordance with the present invention; and

FIG. 8 is a plan view of a seventh exemplary embodiment of a rawhide pet chew in the shape of the Statue of Liberty in accordance with the present invention.

### DETAILED DESCRIPTION OF THE PRESENT INVENTION

For the purposes of the present application, the term “rawhide” generally refers to cattle hides, however, for purposes of this invention “rawhide”includes the skin of all types of animals, including but not limited to, cleft foot animals, hoofed animals, bovine, livestock, buffalo, pigs, poultry, and suitable aquatic animals or fish. The rawhide need not be explicitly “raw” and may have some treatment not deleterious to carnivorous animals, particularly dogs.

For the purposes of the present application the term “pet chew” is intended to refer to a chew object for any desired domesticated animal (including, but not limited to, a dog or a cat).

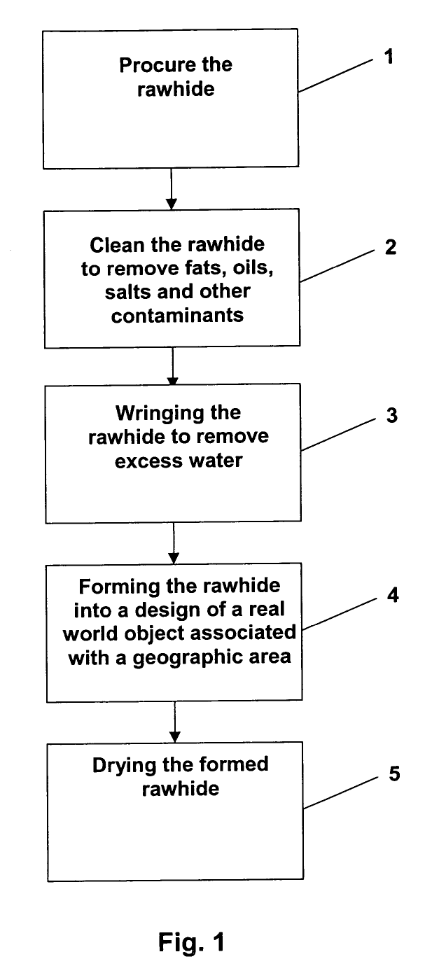

Rawhide pet chews according to the present invention are generally processed according to standard practices that ultimately undergo separate forming processes. With reference to FIG. 1, the process of the present invention begins with the step of procuring rawhide in a split lime state (step 1), generally as by-products from tanneries. Next, the rawhide is treated with various known chemicals to remove hair, fats, oils, salts, and other contaminants (step 2). The rawhide may also be washed and whitened using hydrogen peroxide. Standard practices for processing rawhide typically include additional steps that are known in the industry, for example, checking the pH of the rawhides. The rawhide is then dried or pressed to remove excess water (step 3). While still at least slightly wet, the rawhides are formed into a design of an object primarily associated with a geographic area (step 4). This step may be performed by various methods including, but not limited to, stamping, cutting and molding. Next, the formed rawhides are dried in ovens (e.g., for a number of days) until dry (step 5). Care should be taken not to dry the pet chews too quickly because, while the exterior of the pet chews may appear dry, the interior, if still moist, can mold and deteriorate before the pet chew reaches the consumer for purchase. Once dried, the result is a rawhide pet chew as hard as bone. The rawhides may be basted or coated with a number of well known mixtures to prevent the pet chew from becoming hard, with a shiny, slightly lumpy appearance. Further, the rawhides may be dyed a color to portray the desired design as realistically as possible and increases the appeal of the pet chew to the pet owner or the pet. Finally, the rawhides may be printed, engraved, or embossed with letters, numbers, symbols, and geographic shapes to further delineate the desired design as close as possible and designate the specific geographic area in which the pet chew will be marketed.

The inventive pet chew may be prepared in multiple forms and designs to appeal to different pet owners and pets and formed by any convenient technique known or heretofore developed in the art, such as molding, stamping, and cutting. In press molding, a suitable volume of rawhide is placed into a heated mold and the mold is closed to conform the rawhide to the shape of the mold. In a variation, a die depicting the desired form or design is encased in a rawhide sheet of suitable size. The rawhide is pressed and heated to conform the rawhide to the shape of the die. In injection molding, the rawhide is cut or ground into bits or small pieces of a predetermined size, mixed with a liquid adherent, and placed into a closed mold and baked or otherwise dried to solidify the rawhide in the form of the mold. In another variation, rawhide is cut into the desired design by using a knife or by stamping out shaped pieces from the rawhide sheet. In still another variation, the rawhide can be extruded through a die imparting a desired peripheral shape to form an extrudate rawhide rope. The rawhide rope can be cut to form individually shaped pieces.

The figurative rawhide pet chew of the present invention, as described, is a unique and imaginative item that expands the variety of rawhide pet chews beyond the typical shapes and forms associated with pets. It is envisioned that the present invention will find favor and be popular with visitors and tourists, as a commemorative souvenir of the territories and states of the United States they visited and as a gift to family and friends, including pets, upon their return. However, the present invention is not limited to the United States and its territories. The present invention is useful for other countries and tourist destinations such as Japan, Mexico, Egypt, and France.

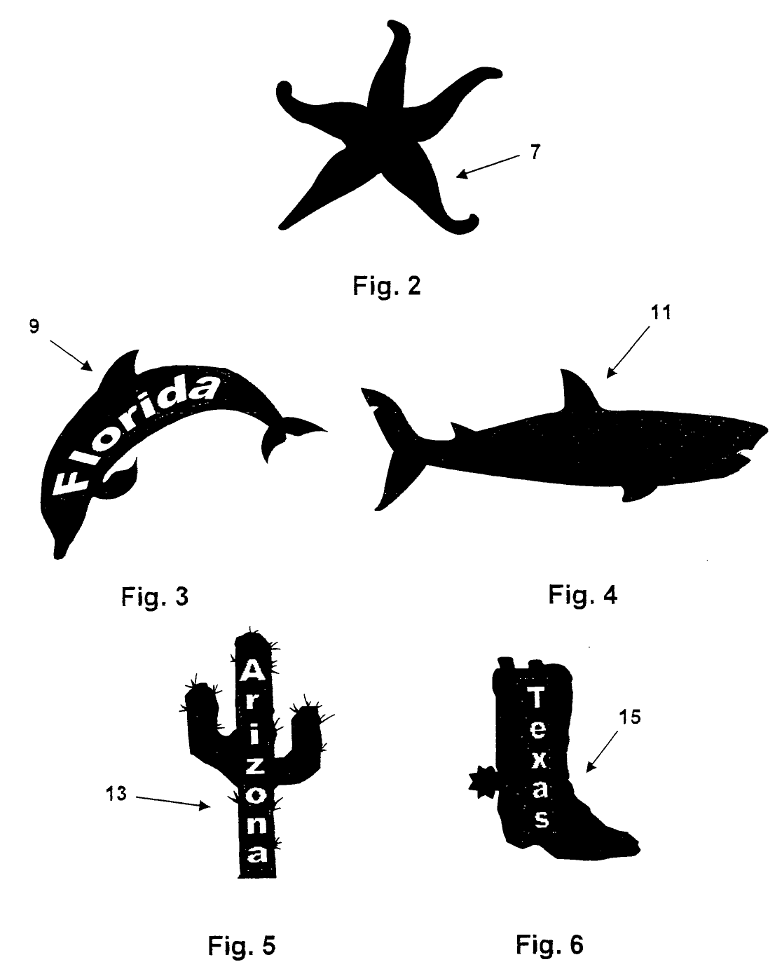

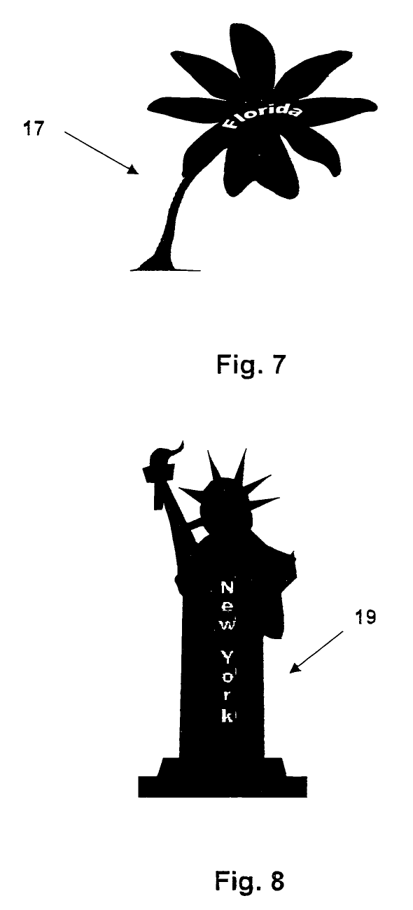

With reference to FIGS. 2-6, exemplary shapes of the disclosed pet chew may include alligators, starfish 7, dolphins 9, sharks 11 or sea shells, to represent the state of Florida and cactuses 13, cowboy boots 15, poker chips or cows to represent western states, such as Arizona or Texas. Further the geographic areas may include an entire state or a city within that state. For example, with reference to FIGS. 7 and 8, a palm tree 17 may represent the state of Florida or the city of Ft. Lauderdale, Fla. and the Statue of Liberty 19 may represent New York City. Further, the pet chews may take the shape of famous people to symbolize cites, such as Abraham Lincoln to represent Washington, D.C. Additionally, the pet chews may take the shape of inanimate objects to commemorate an event, such as the Pittsburgh Steelers' emblem, to represent a sporting event.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method of manufacturing a rawhide pet chew comprising the steps of:
processing a rawhide;
forming the rawhide into a design of an object primarily associated with a geographic area while still wet; and
drying the rawhide.

2. The method of claim 1, further comprising dying the pet chew a color primarily associated with the object.

3. The method of claim 1, wherein the object is selected from the group consisting of animals, plants, landmarks, famous people, and inanimate objects.

4. The method of claim 1, wherein the geographic area is a state or territory of the United States.

5. The method of claim 1, wherein the step of forming is selected from the group consisting of molding, stamping and cutting.

6. The method of claim 1, wherein the step of processing further includes:
obtaining rawhide;
cleaning the rawhide to remove fats, oils, salts and other contaminants; and
wringing the rawhide to remove excess water.

7. An improved rawhide pet chew wherein the improvement comprises:
forming the pet chew into an object primarily associated with a geographic area.

8. The improved rawhide pet chew of claim 5, wherein the pet chew is dyed a color primarily associated with the object.

9. The improved rawhide pet chew of claim 5, wherein the object is selected from the group consisting of an animal, plant, landmark, and inanimate object.

10. The improved rawhide pet chew of claim 5, wherein the geographic area is a state or territory of the United States.

11. A rawhide pet chew made by the process of:
processing a rawhide;
forming the rawhide into a design of an object primarily associated with a geographic area while still wet; and
drying the rawhide.

12. The rawhide pet chew of claim 9, wherein the pet chew is dyed a color primarily associated with the object.

13. The rawhide pet chew of claim 9, wherein the object is selected from the group consisting of animals, plants, landmarks, famous people, and inanimate objects.

14. The rawhide pet chew of claim 9, wherein the geographic area is a state or territory of the United States.

15. The rawhide pet chew of claim 9, wherein the step of forming is selected from the group consisting of molding, stamping and cutting.

16. The rawhide pet chew of claim 9, wherein the step of processing further includes:
obtaining rawhide;
cleaning the rawhide to remove fats, oils, salts and other contaminants; and wringing the rawhide to remove excess water.
